(19) United States
(12) Patent Application Publication
(10) Pub. No.: US 2010/0260235 A1
(43) Pub. Date: Oct. 14, 2010

(54) PILOT TRANSMISSION METHOD, MIMO TRANSMISSION DEVICE, MIMO RECEPTION DEVICE WHICH PERFORMS COMMUNICATION WITH MIMO TRANSMISSION DEVICE

(75) Inventors: Isamu Yoshii, Kanagawa (JP); Atsushi Sumasu, Kanagawa (JP); Tomohiro Imai, Kanagawa (JP); Hidenori Kayama, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/746,466

(22) PCT Filed: Dec. 10, 2008
(86) PCT No.: PCT/JP2008/003694

§ 371 Date: Jun. 4, 2010

(30) Foreign Application Priority Data
Dec. 11, 2007 (JP) 2007-320075

(51) Int. Cl. H04B 1/707

(52) U.S. Cl. 375/146; 375/147; 375/E01.002

(57) ABSTRACT

It is possible to provide a novel pilot transmission method which can calculate an accurate channel estimation value, a MIMO transmission device using the pilot transmission method, and a MIMO reception device which performs communication with the MIMO transmission device. The MIMO transmission device (100) includes a cyclic shift processing unit (150) which cyclically shifts a first pilot signal sequence spread by a spread code 1 and second pilot signal sequence spread by a spread code 2 with different shift amounts. The first pilot signal sequence and the second pilot signal sequence which have been cyclically shifted are transmitted from different transmitting antennas at the same pilot transmission symbol section. Thus, by changing the shift amount of the cyclic shift process executed on each pilot signal sequence spread by the respective spread codes, it is possible to improve the pilot separation accuracy at a reception side. This enables more accurate calculation of a channel estimation value.

### TECHNICAL FIELD

The present invention relates to a pilot transmission method, a MIMO transmission apparatus and a MIMO reception apparatus that communicates with the MIMO transmission apparatus.

### BACKGROUND ART

In recent years, MIMO (Multiple-Input/Multiple-Output) communication is attracting attention as a technology to allow communication of large volume of data such as images. With this MIMO communication, a plurality of antennas on the transmitting side transmit different transmission data (substreams) and received data formed by mixing a plurality of transmission data on channels is separated into the original transmission data on the receiving side. When this separation processing is performed, channel estimation values are required.

Patent Document 1 discloses a method of channel estimation in a MIMO communication system (OFDM-MIMO communication system) adopting the OFDM (Orthogonal Frequency Division Multiplexing) system.

On the MIMO transmission apparatus side of the OFDM-MIMO communication system disclosed in Patent Document 1, first, an OFDM symbol (hereinafter may be referred to as “pilot OFDM symbol”) is formed by signal sequences generated in a pilot signal sequence generating section as shown in FIG. 1. In this pilot OFDM symbol, the same signal is superimposed on all subcarriers, and therefore the pilot OFDM appears an impulse in the time domain.

Then, these pilot OFDM symbols are subjected to cyclic shift processing with different amounts of shift per antenna, attached cyclic prefixes (CPs), and transmitted from a plurality of antennas.

Here, the cyclic shift processing is processing to move the part corresponding to k samples from the end of a pilot OFDM symbol, to the beginning of that OFDM symbol, and sequentially shift parts other than this moved part k samples backward. That is, the beginning position of a pilot OFDM symbol before cyclic shift processing (hereinafter may be referred to as “initial first position”) is shifted k samples backward after cyclic shift processing.

Therefore, although the MIMO transmission apparatus in FIG. 1 transmits pilot OFDM symbols from two antennas at the same timing, the initial first position is shifted k samples in the OFDM symbols (see FIG. 3).

On the MIMO reception apparatus side of the OFDM-MIMO communication system, a range of k samples from the initial first position in a pilot OFDM symbol is actually used as “pilot.” Therefore, the MIMO transmission apparatus shifts pilots by k samples in the time domain between antennas by applying cyclic shift processing to pilot OFDM symbols. Here, in order to prevent interference between pilot OFDM symbols transmitted from different antennas, k samples are practically set equal to or more than the maximum multipath delay time.

After receiving each pilot OFDM symbol transmitted as described above, the MIMO reception apparatus first removes the CPs. Then, MIMO reception apparatus extracts the first k-sample part and the subsequent parts from each received pilot OFDM symbol without CPs. That is, the MIMO reception apparatus performs separating processing of pilots transmitted from respective transmitting antennas on the assumption that the first k-sample part is the multipath of transmitting antenna 1 and the subsequent parts are the multipath of antenna 2. FFT processing is performed on both sampled parts. This processing is performed per receiving antenna of the MIMO reception apparatus. Then, the results of FFT processing calculated for all combinations of transmitting antennas and receiving antennas are used to calculate channel estimation values.

Here, a sample length for allocating transmitting antennas, that is, the above-described k samples, is determined in accordance with the maximum delay time, under the limitation that k samples are equal to or shorter than an OFDM symbol.

Since there is no correlation between an OFDM symbol length and the maximum delay time, there are “remaining samples (time domain)” in an OFDM symbol if k samples determined in accordance with the maximum delay time are arranged in the OFDM symbol without overlapping. Since these remaining samples are shorter than the maximum delay time, with the above-described MIMO transmission apparatus, there are parts not allocated to the pilots transmitted from other antennas, that is, parts carrying no information available to the receiving side in a pilot symbol.

### Patent Document 1: Japanese Patent Application Laid-Open No. 2007-20072

### DISCLOSURE OF INVENTION

### Problems to be Solved by the Invention

Here, in a case of MIMO communication, since spatial-multiplexed signals resulting from spatial-multiplexing data streams transmitted from respective transmitting antennas are received on the receiving side, separation processing of received signals is required. Therefore, it is highly necessary to calculate more accurate channel estimation values.

In view of the above-described problems, it is therefore an object of the present invention to provide a new pilot transmission method to allow the calculation of more accurate channel estimation values, a MIMO transmission apparatus using this pilot transmission method and a MIMO reception apparatus that communicates with this MIMO transmission apparatus.

### Means for Solving the Problem

The pilot transmission method according to the present invention is a pilot transmission method in a multiple-input/multiple-output transmission apparatus that transmits pilots from a plurality of transmitting antennas. The pilot transmission method has a configuration including the steps of: generating pilot signal sequences including the pilots as part of the sequences; spreading the pilot signal sequences by a plurality of spread codes differing each other; cyclic-shifting a first pilot signal sequence spread by a first spread code and a second pilot signal sequence spread by a second spread code with amounts of shift differing one another; and transmitting the cyclic-shifted first pilot signal sequence and second pilot signal sequence in the same pilot transmission symbol period from different antennas.

The MIMO transmission apparatus according to the present invention is to transmits pilots from a plurality of transmission antennas. The MIMO transmission apparatus has a configuration including: a pilot signal sequence generating section that generates pilot signal sequences including the pilots as part of the sequences; a spreading section that spreads individually the pilot signal sequences by a plurality of different spread codes; a cyclic shift section that cyclic-shifts a first pilot signal sequence spread by a first spread code and a second pilot signal sequence spread by a second spread code with amounts of shift differing one another; and a transmitting section that transmits the cyclic-shifted first pilot signal sequence and second pilot signal sequence in the same pilot transmission symbol period from different antennas.

The MIMO reception apparatus according to the present invention has a configuration including: a delay profile creating section that creates delay profiles of received pilots; a despreading section that despreads the created delay profiles; a path sampling section that samples paths in the created delay profiles or the delay profiles after despreading using time windows; and a channel estimation value calculating section that calculates channel estimation values based on the sampled paths. The path sampling section switches the time windows between a multiple-input/multiple-output receiving mode and a cyclic delay diversity receiving mode.

### ADVANTAGEOUS EFFECTS OF INVENTION

The present invention can provide a new pilot transmission method to allow the calculation of more accurate channel estimation values, a MIMO transmission apparatus using this pilot transmission method and a MIMO reception apparatus that communicates with this MIMO transmission apparatus.

### BRIEF DESCRIPTION OF DRAWINGS

FIG. 1 is a drawing explaining a conventional OFDM-MIMO communication system;

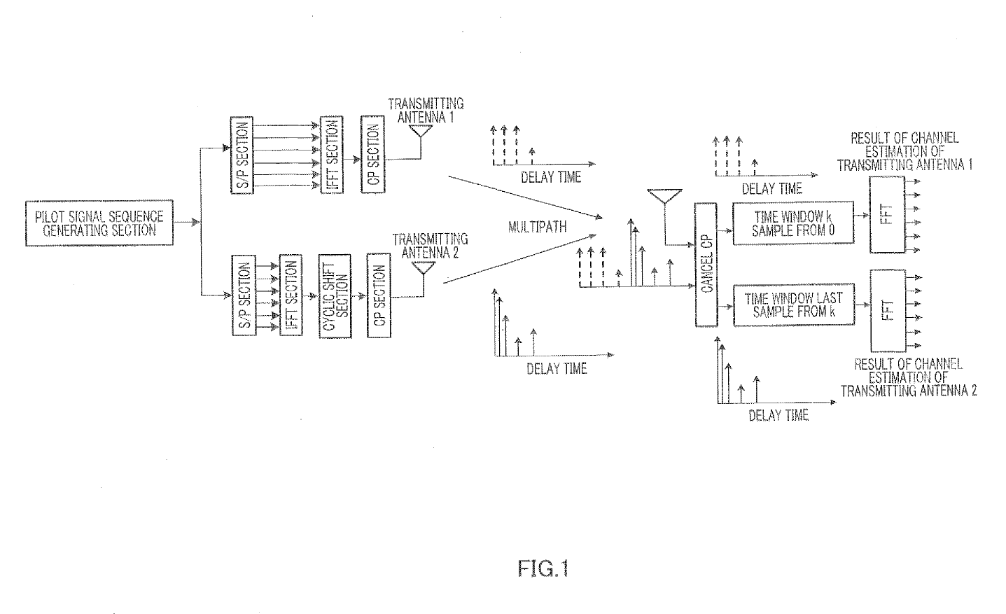

FIG. 2 is a drawing explaining cyclic shift processing;

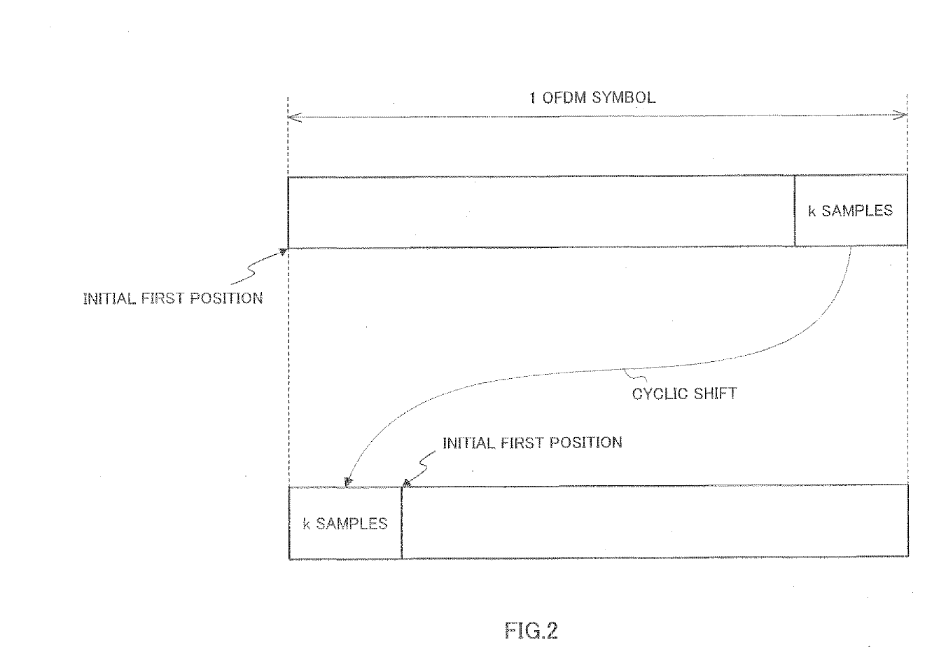

FIG. 3 is a drawing explaining pilot transmission of a conventional MIMO transmission apparatus;

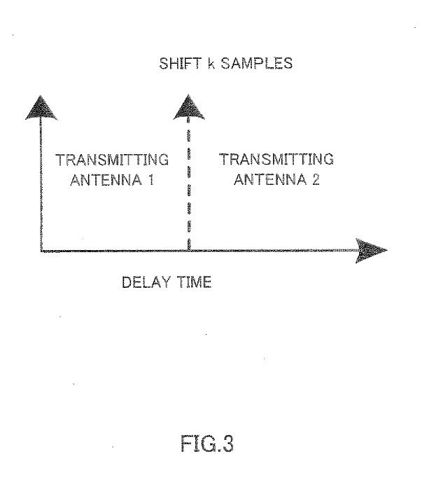

FIG. 4 is a block diagram showing a configuration of a MIMO transmission apparatus according to embodiment 1 of the present invention;

FIG. 5 is a block diagram showing a configuration of a MIMO reception apparatus according to embodiment 1;

FIG. 6 is a drawing explaining operations of the MIMO transmission apparatus in FIG. 4;

FIG. 7 is a drawing explaining operations of the MIMO transmission apparatus in FIG. 4 and the MIMO reception apparatus in FIG. 2;

FIG. 8 is a drawing explaining creation and extraction processing of delay profiles in the MIMO reception apparatus in FIG. 5;

FIG. 9 is a drawings explaining a technology to be compared;

FIG. 10 is a drawings explaining the technology to be compared;

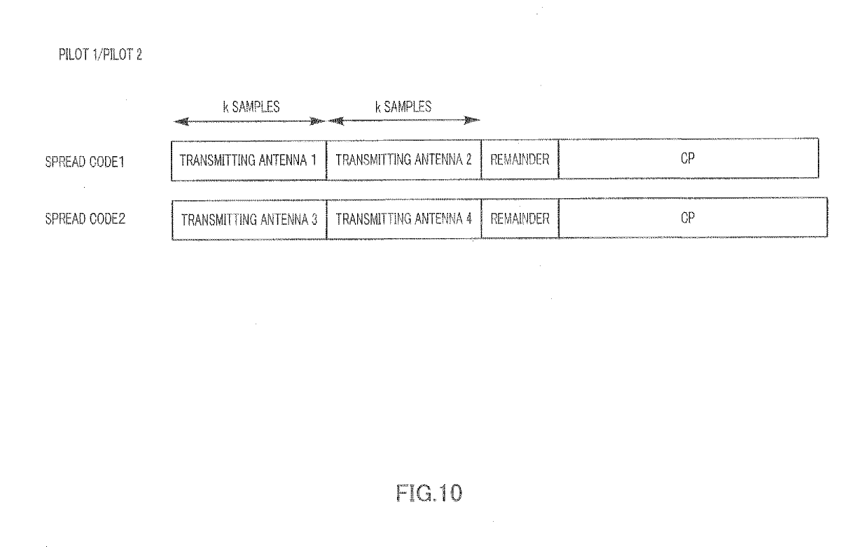

FIG. 11 is a drawings explaining the technology to be compared;

FIG. 12 is a block diagram showing a configuration of a MIMO transmission apparatus according to embodiment 2;

FIG. 13 is a block diagram showing a configuration of a MIMO reception apparatus according to embodiment 2;

FIG. 14 is a drawing explaining operations of the MIMO transmission apparatus in FIG. 12.

FIG. 15 is a drawing explaining operations of the MIMO transmission apparatus in FIG. 12 and the MIMO reception apparatus in FIG. 10.

### BEST MODE FOR CARRYING OUT THE INVENTION

Now, embodiments of the present invention will be described in detail with reference to the accompanying drawings. Here, the same components in embodiments will be assigned the same reference numerals and overlapping descriptions will be omitted.

### Embodiment 1

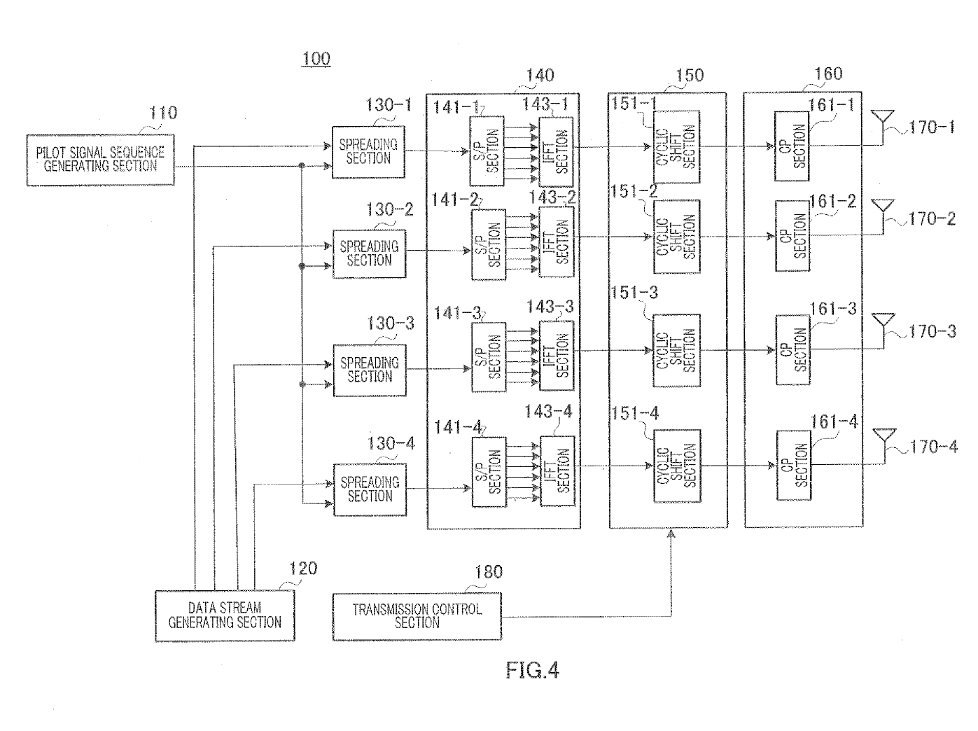

As shown in FIG. 4, MIMO transmission apparatus 100 in the MIMO-OFDM/CDMA communication system according to the present embodiment has pilot signal sequence generating section 110, data stream generating section 120, the same number of N spreading sections 130 as transmission systems, OFDM signal generating section 140, cyclic shift processing section 150, CP adding processing section 160, transmitting antennas 170-1 to N (here N=4) and transmission control section 180. Here, although the number of antennas is four for ease of explanation (equal to the number of transmission systems), the number of antennas is not limited to this.

Pilot signal sequence generating section 110 generates pilot signal sequences including pilots in part of the sequences and outputs them to spreading section 130. Pilot signal sequence generating section 110 outputs pilot signal sequences in accordance with pilot transmission symbol periods.

Data stream generating section 120 forms data streams to be transmitted from respective transmission systems, and outputs the formed data streams to spreading section 130. Data streams generating section 120 outputs data streams in accordance with data transmission periods.

Spreading section 130 receives pilot transmission signal sequences and data streams as input and spreads inputted signals using spread codes. Here, spreading sections 130-1 and 2 use spread code 1 while spreading sections 130-3 and 4 use spread code 2 orthogonal to spread code 1. In addition, spreading sections 130-1 and 2 perform spreading processing with spread code 1 having the same phase in all pilot transmission symbol periods. On the other hand, spreading sections 130-3 and 4, which perform spreading processing with spread code 2, using spread codes having reverse phases between neighboring pilot transmission symbol periods.

OFDM signal generating section 140 has S/P sections 141-1 to 4 and IFFT sections 143-1 to 4. OFDM signal generating section 140 has a set of S/P section 141 and IFFT section 143 corresponding to each transmission system.

OFDM signal generating section 140 receives pilot signal sequences and data streams after spreading processing as input per transmission system. OFDM signal generating section 140 forms OFDM symbols by serial-parallel converting inputted signals and then inverse Fourier transforming the results. OFDM signal generating section 140 outputs the formed OFDM symbols to cyclic shift processing section 150 per transmission system.

Cyclic shift processing section 150 has cyclic shift sections 151-1 to 4 corresponding to transmission systems, respectively. Cyclic shift processing section 150 receives OFDM symbols as input per transmission system. Cyclic shift processing section 150 cyclic-shifts the inputted OFDM symbols based on cyclic shift control information inputted from transmission control section 180. Cyclic shift processing section 150 outputs the OFDM symbols after cyclic shift processing to CP adding processing section 160.

CP adding processing section 160 has CP sections 160-1 to 4 corresponding to transmission systems, respectively. CP adding processing section 160 receives a pilot OFDM symbol after cyclic shift as input per transmission system and adds a CP to that. The pilot OFDM symbol with a CP is transmitted from antenna 170 per transmission system.

Transmission control section 180 controls the amount of cyclic shift in each cyclic shift section 151 by outputting cyclic shift control information to cyclic shift processing section 150. Here, only part of pilot signal sequences, that is, only pilot parts are used to calculate channel estimation values on the receiving side, as described later. Transmission control section 180 allocates a different amount of cyclic shift to each transmission system, so that transmission timings of pilots transmitted from each transmission system are adjusted. In addition, the amount of cyclic shift for a data stream is zero.

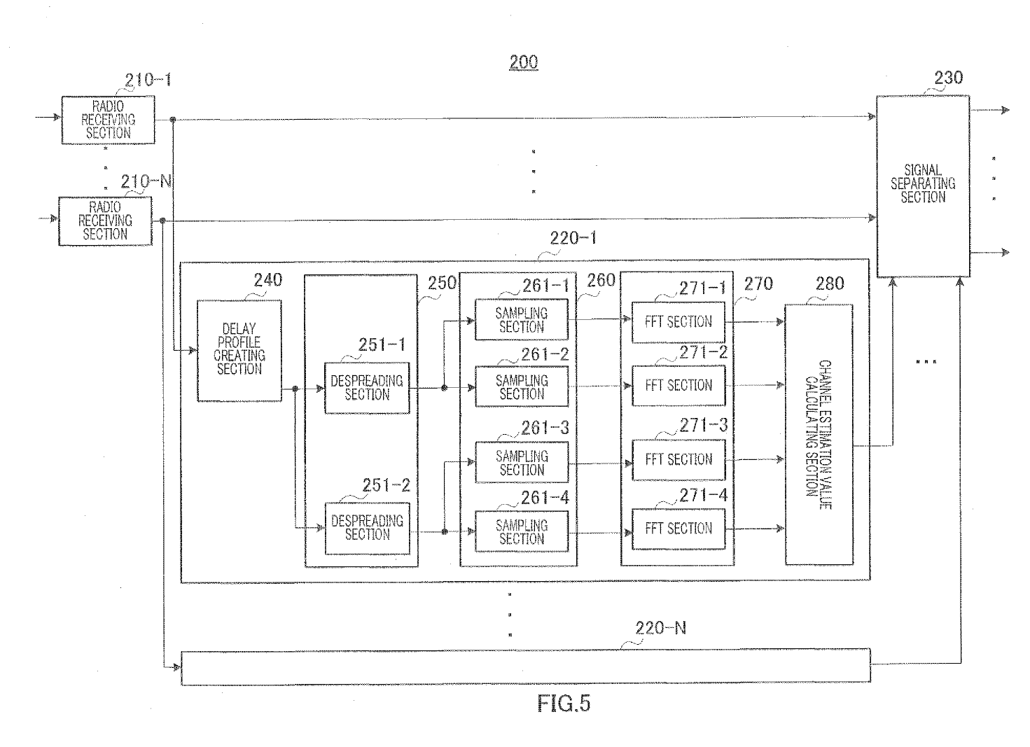

As shown in FIG. 5, MIMO reception apparatus 200 in the MIMO-OFDM communication system according to the present embodiment has radio receiving sections 210-1 to N corresponding to N receiving antennas (not shown), respectively, channel estimating sections 220-1 to N and signal separating section 230.

Radio receiving sections 210-1 to N perform predetermined radio receiving processing (e.g., down-conversion and A/D conversion) on received signals received by corresponding receiving antennas, respectively, remove the CPs and send the obtained signals to respectively corresponding channel estimating sections 220-1 to N and signal separating section 230.

Channel estimating sections 220-1 to N receive receiving OFDM signals from corresponding radio receiving sections 210-1 to N, respectively, and calculate channel estimation values using pilots included in these received OFDM signals. Each of channel estimating sections 220-1 to N calculates channel estimation values relating to subcarriers between the corresponding receiving antenna and each transmitting antenna of MIMO transmission apparatus 100.

To be more specific, channel estimating section 220 has delay profile creating section 240, despread processing section 250, path sampling processing section 260, FFT processing section 270 and channel estimation value calculating section 280.

Delay profile creating section 240 creates a delay profile from the OFDM signal received as input.

Despread processing section 250 has the same number of despreading sections 251 as spread codes used on the transmitting side. Here, since two types of spread codes (the above-described spread code 1 and spread code 2) are used on the transmitting side, despreading sections 251-1 and 2 are shown in the figure.

Despread processing section 250 performs despread processing on delay profiles created in delay profile creating section 240 using respective spread codes. Despread processing section 250 calculates “an added delay profile” by adding up two delay profiles for spread code 1 obtained in two pilot transmission symbol periods. Meanwhile, despread processing section 250 calculates “a subtracted delay profile” by subtracting two delay profiles for spread code 2 obtained in two pilot transmission symbol periods. Here, the powers of paths are combined when the added delay profile and the subtracted delay profile are calculated. By this means, SIR of pilots is improved, so that it allows the calculation of more accurate channel estimation values.

Path sampling processing section 260 samples a pilot OFDM symbol part in the delay profile. To be more specific, path sampling processing section 260 receives delay profiles despread in despread processing section 250 using respective spread codes. Then, path sampling processing section 260 samples each delay profile after despread processing using preset time windows. Time windows used for sampling are set according to the relative temporal positional relationships between a plurality of pilots spread by the same spread code on the transmitting side, in pilot OFDM symbol periods.

To be more specific, path sampling processing section 260 has sampling sections 261-1 and 2 that sample the added delay profile and sampling sections 261-3 and 4 that sample the subtracted delay profile.

Sampling section 261-1 samples delay profiles using the time window corresponding to the pilots spread by spreading section 130-1. Sampling section 261-2 samples delay profiles using the time window corresponding to the pilots spread by spreading section 130-2.

Sampling section 261-3 samples delay profiles using the time window corresponding to the pilots spread by spreading section 130-3. Sampling section 261-4 samples delay profiles using the time window corresponding to the pilots spread by spreading section 130-4.

FFT processing section 270 performs Fourier transform processing on each delay profile sampled in path sampling processing section 260. Here, FFT processing section 270 has FFT sections 271-1 to 4 respectively corresponding to path sampling sections 261-1 to 4.

Channel estimation value calculating section 280 calculates channel estimation values using FFT processing results obtained in FFT processing section 270.

Signal separating section 230 separates a received OFDM signal (specifically, data part included in a received OFDM signal) into a plurality of data streams (corresponding to transmission data streams on the transmitting side) included in the received OFDM signal using channel estimation values corresponding to all combinations of transmitting antennas, receiving antennas and sub carriers obtained in channel estimating sections 220-1 to N.

Now, operations of MIMO transmission apparatus 100 and MIMO reception apparatus 200 in the MIMO-OFDM/CDMA communication system having the above-described configuration will be described.

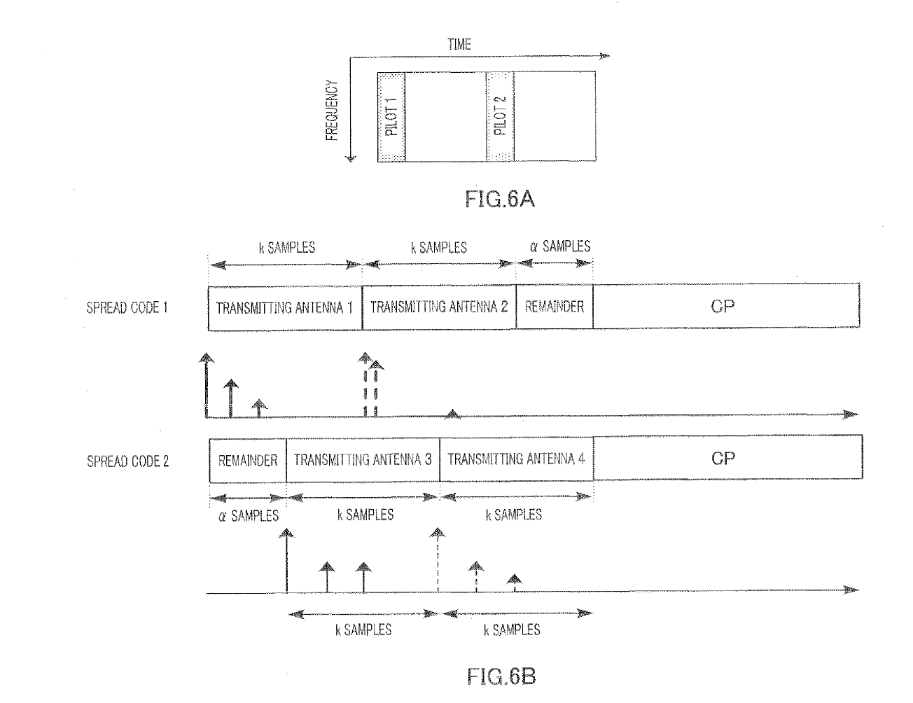

MIMO transmission apparatus 100 transmits pilots from each antenna using two OFDM symbols as shown in FIG. 6A. In FIG. 6A, the pilot transmitted in the first pilot transmission symbol period is pilot 1 and the pilot transmitted in the second pilot transmission symbol period is pilot 2.

For each pilot transmission symbol period, cyclic shift processing is performed on pilot signal sequences with varying amounts of shift per transmission system.

To be more specific, as for pilots spread by spread code 1, the amount of cyclic shift for the pilot signal sequence transmitted from transmitting antenna 1 is zero, and the amount of cyclic shift for the pilot signal sequence transmitted from transmitting antenna 2 is k, as shown in FIG. 6B. Then, there is the time domain of a remaining sample having a time length of a samples shorter than k samples in a pilot transmission symbol period (having a time length of one OFDM symbol). Here, since the part of k samples from the initial first position in pilot signal sequences are used as a pilot as described later, the length of k samples is equal to a pilot length.

On the other hand, as for pilots spread by spread code 2, the amount of cyclic shift for the pilot signal sequence transmitted from transmitting antenna 3 is β samples shorter than k samples, and the amount of cyclic shift for the pilot signal sequence transmitted from transmitting antenna 4 is k+β samples. FIG. 6B shows a case where β=a, that is, a case where β has the same length as the time length of remaining samples.

That is, the difference in the amount of cyclic shift between a plurality of pilots spread by the same spread code is equal to a pilot length (here, a difference of k samples). Moreover, a plurality of pilots spread by different spread codes (for example, pilots transmitted from transmitting antenna 1 and transmitting antenna 3) are relatively shifted by predetermined samples (here, β samples).

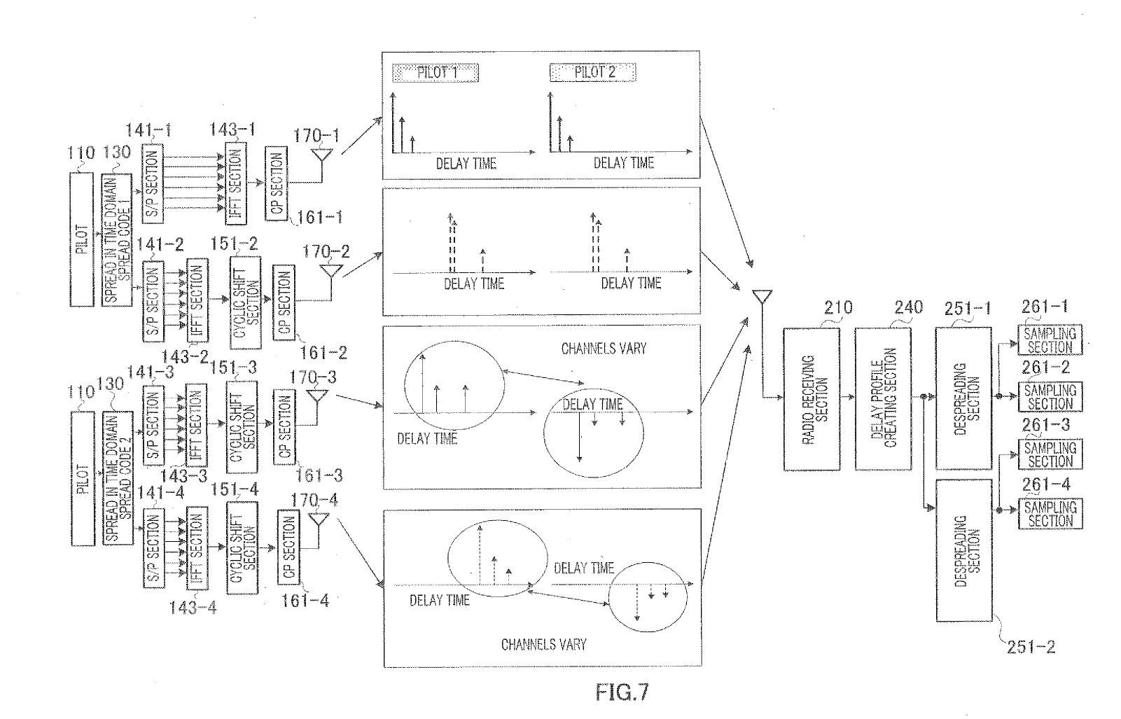

In addition, as shown in FIG. 7, spread code 1 has the same phase in all pilot transmission symbol periods while spread code 2 has reverse phases between neighboring pilot transmission symbol periods.

Pilots transmitted as described above go through a plurality of paths as shown in FIG. 7 and then are received in MIMO reception apparatus 200.

MIMO reception apparatus 200 first performs processing of pilots transmitted in the first pilot transmission symbol period. That is, after performing radio receiving processing on received signals and removing the CPs from the processed signals, MIMO reception apparatus 200 creates delay profiles in delay profile creating section 240.

In addition, MIMO reception apparatus 200 processes pilots transmitted in the second pilot transmission symbol period. That is, after performing radio receiving processing on received signals and removing the CPs from the processed signals, MIMO reception apparatus 200 creates delay profiles in delay profile creating section 240.

Despreading sections 251-1 and 2 receive the delay profiles created in the first and second pilot transmission symbol periods, as input.

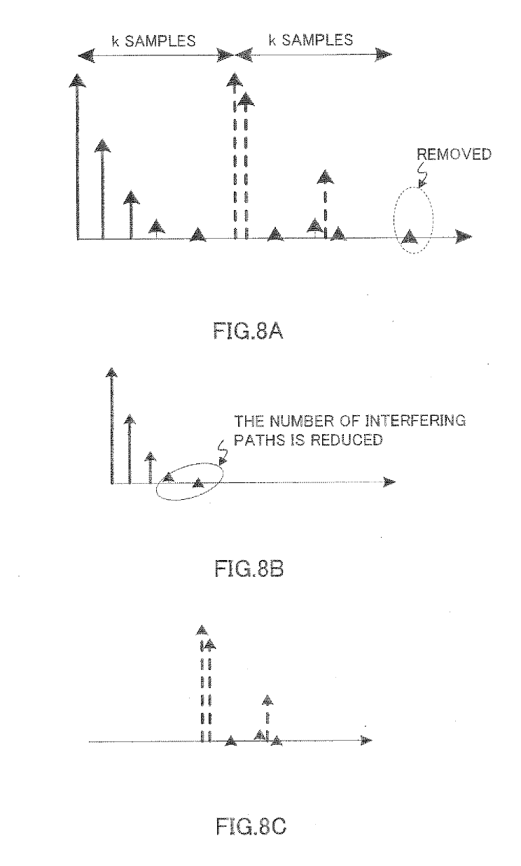

Despreading section 251-1 performs despread processing on respective delay profiles created in the first and second pilot transmission symbol periods using spread code 1. In addition, despreading section 251-1 calculates an added delay profile by adding up both the delay profiles after despread processing, whose origins are aligned. FIG. 8A shows the added delay profile obtained at this time. The arrows indicated by bold solid lines correspond to paths of pilots transmitted from antenna 1, the arrows indicated by bold dashed lines correspond to paths of pilots transmitted from antenna 2, the arrows indicated by thin solid lines correspond to paths of pilots transmitted from antenna 3 and the arrows indicated by thin dashed lines correspond to paths of pilots transmitted from antenna 4.

Here, if channels do not change between the first pilot transmission symbol period and the second pilot transmission symbol period because of slow variation, the paths of pilots transmitted from antenna 3 and antenna 4 in FIG. 8A theoretically do not appear. The reason is that the pilots transmitted from antenna 3 and antenna 4 are spread by spread code 2 having reverse phases between the first pilot transmission symbol period and the second pilot transmission symbol period, so that offset occurs when the added delay profile is created unless channels vary.

In the same way, despreading section 251-2 performs despread processing on respective delay profiles created in the first and second pilot transmission symbol periods using spread code 2. Moreover, despreading section 251-2 calculates a subtracted delay profile by normalizing and subtracting both delay profiles after despread processing. Here, when channels do not vary, paths for pilots transmitted from antenna 1 and antenna 2 theoretically do not appear, which are spread by spread code 1 in the same phase in both periods.

The added delay profile is inputted to sampling section 261-1 and sampling section 261-2. Then, sampling section 261-1 samples paths using the time window of k samples corresponding to the pilot transmission symbol period for antenna 1 (see FIG. 8B). Meanwhile, sampling section 261-2 samples paths using the time window for k samples corresponding to the pilot transmission symbol period for antenna 2 (see FIG. 8C). That is, the time windows used in sampling section 261-1 and sampling section 261-2 are shifted by k samples, which is the difference between transmission timings of pilots transmitted from antenna 1 and antenna 2 on the transmitting side.

[Technology to be Compared]

Now, an embodiment will be described that is realized by combining the above-described OFDM-MIMO communication system and the CDMA communication technology, as a technology to be compared to the present embodiment.

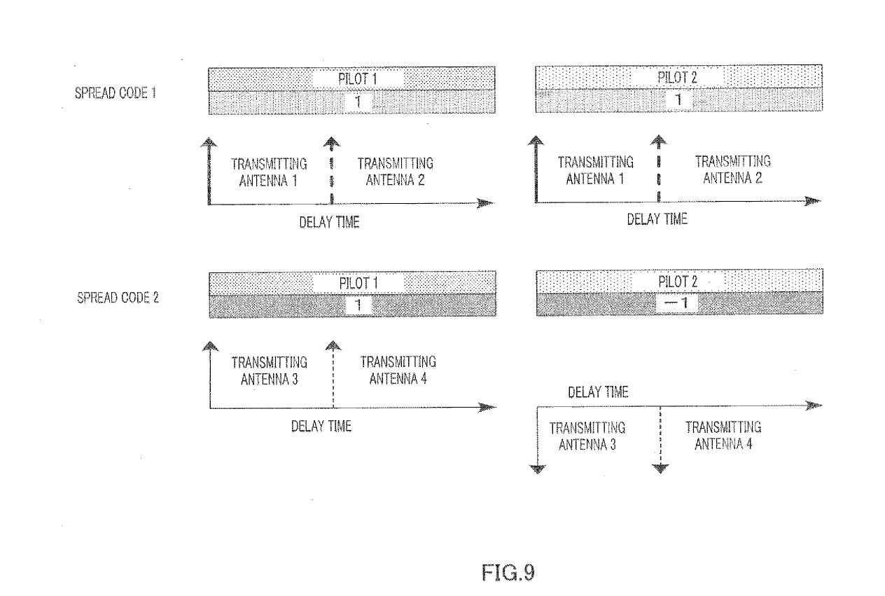

In the same way as in the above-described MIMO transmission apparatus 100, all antennas transmit pilots in the first and second transmission symbol periods as shown in FIG. 9. At this time, the pilots transmitted from antenna 1 and antenna 2 are spread by spread code 1 and the pilots transmitted from antenna 3 and antenna 4 are spread by spread code 2. In addition, as for the pilots spread by spread code 2, phases reverse between any two neighboring pilot transmission symbol periods.

Unlike the case of the above-described MIMO transmission apparatus 100, however, the pilots spread by spread code 1 and the pilots spread by spread code 2 are transmitted without a difference between the transmission timings. That is, the pilots transmitted from antenna 1 and antenna 3 are transmitted at the same timing, and the pilots transmitted from antenna 2 and antenna 4 are transmitted at the same timing.

The added delay profile and the subtracted delay profile of pilots transmitted in the above-described state are calculated on the receiving side in the same way as MIMO reception apparatus 200. Also in this case, if channels vary between the first pilot transmission symbol period and the second pilot transmission symbol period as described above, paths (interfering paths) of pilots, which theoretically should not appear, transmitted from the antennas appear.

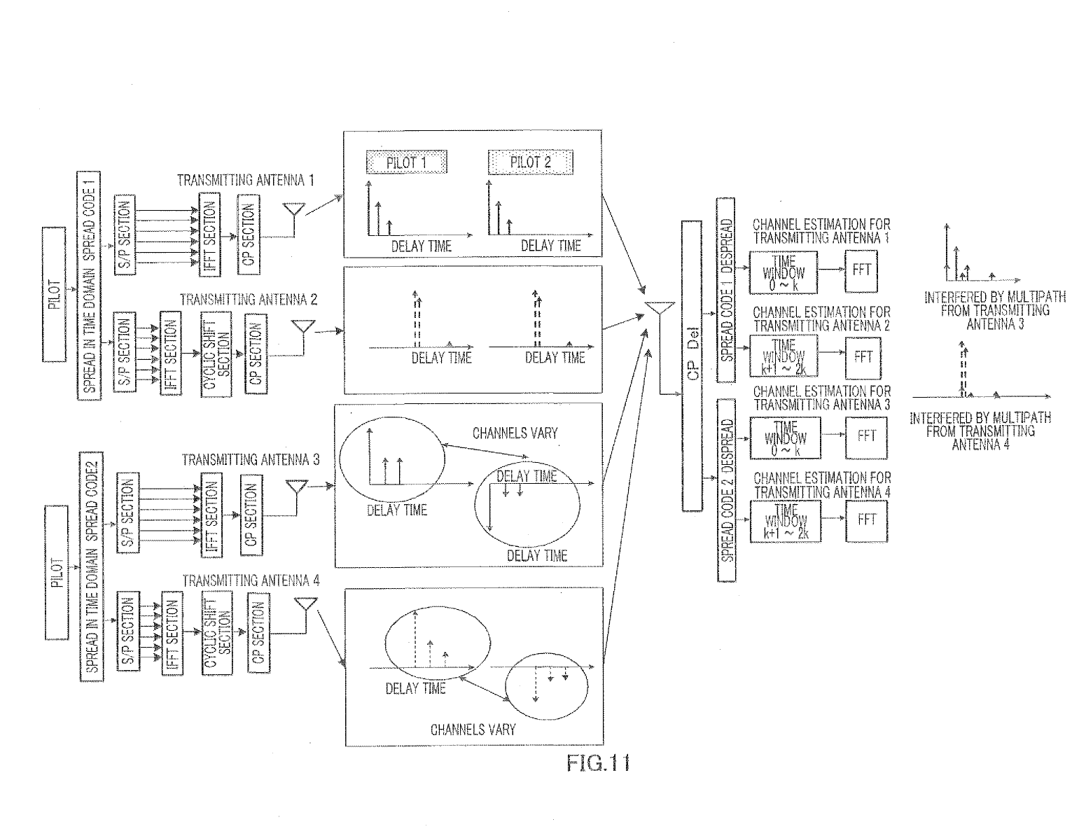

Here, as described above, the transmitting timings of pilots spread by spread code 1 and the transmitting timings of pilots spread by spread code 2 are the same, so that paths that theoretically should not appear (interfering paths), will appear in exactly the same range as the range in which the sampling target paths (desired paths) appear, as understood by the rightmost delay profile in FIG. 11. As a result of this, multipath interference will occur between a plurality of pilots despite transmitting the plurality of pilots using different spread codes from the transmitting side so as to prevent multipath interference on the receiving side. With the above-described embodiment, however, the accuracy of pilot separation at a sufficient level can be anticipated if channels vary slow.

On the other hand, MIMO transmission apparatus 100 according to the present embodiment shifts the transmission timings relatively by β samples between pilots spread by spread code 1 and spread code 2 (see FIG. 6B).

As a result of this, in the delay profiles created on the receiving side, the center location in the range in which paths of pilots spread by spread code 1 appear and the center location in the range in which paths of pilots spread by spread code 2 appear are shifted. That is, on the receiving side, even if interfering paths spread by one spread code appear in the added delay profile and subtracted delay profile for the other spread code, the positions in which the interference paths appear shift from the range in which desired paths appear.

Thus, the transmitting timings between pilots respectively spread by different spread codes are shifted on the transmitting side, so that a period of time in which multipaths of respective pilots overlap is shorter in reception. Therefore, the number of interfering paths within the sampling range of desired paths can be reduced even if channels vary fast, so that the accuracy of channel estimation can be improved.

According to the present embodiment as described above, in MIMO transmission apparatus 100, cyclic shift processing section 150 shifts, with amounts of shift differing one another, the first pilot signal sequence (for example, the pilot signal sequence transmitted from the above-described antenna 1) spread by the first spread code (for example, the above-described spread code 1) and the second pilot signal sequence (for example, the pilot signal sequence transmitted from the above-described antenna 2) spread by the second spread code (for example, the above-described spread code 2). Then, the first pilot signal sequence and the second pilot signal sequence having been cyclic-shifted are transmitted in the same pilot transmission symbol period from different antennas.

As described above, two pilot signal sequences transmitted in the same pilot transmission symbol period are spread by different spread codes, so that it allows accurate pilot separation processing on the receiving side. Moreover, it is possible to shift timings multipaths associated with pilots included in pilot signal sequences appear between pilot signal sequences, by changing the amount of shift in cyclic shift processing to apply each pilot signal sequence. By this means, the accuracy of pilot separation on the receiving side can be more improved.

In addition, cyclic shift processing section 150 provides a difference in the amount of shift between the above-described first and second pilot signal sequence less than the pilot length (k samples in the present embodiment). That is, the transmission timings of pilots included respectively in the first pilot signal sequence and the second pilot signal sequence partially overlap each other.

As a result of this, it is possible to increase the number of pilots allowed to be transmitted in one pilot transmission symbol period. That is, it allows efficient pilot transmission.

In addition, the second signal sequence transmitted in two pilot transmission symbol periods temporally nearest are spread by the second code having reverse phases one another.

By this means, it is possible to cancel interfering paths from both the added delay profile and the subtracted delay profile by calculating the added delay profile or the subtracted profile on the receiving side. Moreover, paths are combined when both delay profiles are calculated, it is possible to improve SIR of pilots. Therefore, it is possible to calculate more accurate channel estimation values.

### Embodiment 2

With embodiment 1, a plurality of pilots spread by different spread codes are transmitted at transmission timings relatively shifted. On the other hand, with embodiment 2, although a plurality of pilots spread by different spread codes are transmitted at transmission timings relatively shifted in the same way as in embodiment 1, the shifting method allows utilization of cyclic delay diversity (CDD).

That is, the MIMO transmission apparatus according to the present embodiment shifts relatively and transmits a plurality of pilots spread by the same spread code by providing a difference in the amount of cyclic shift greater than a pilot length. Moreover, the MIMO transmission apparatus according to the present embodiment transmits a plurality of pilots spread by different spread codes at transmission timings relatively shifted in the same way as in embodiment 1.

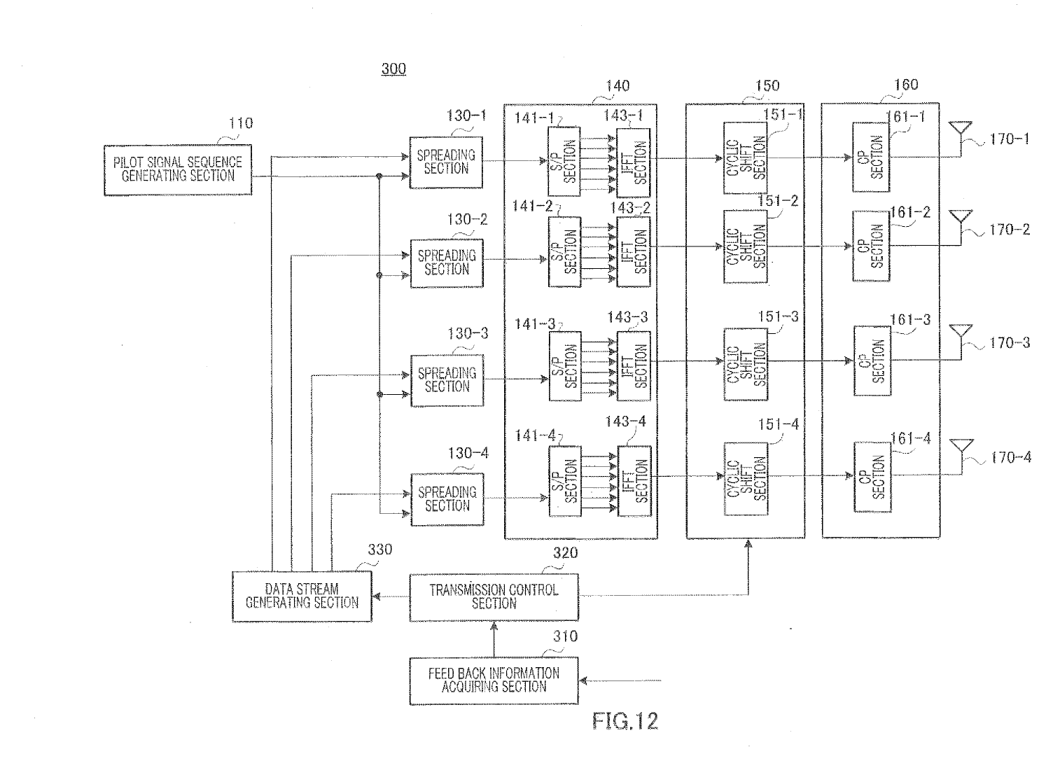

As shown in FIG. 12, MIMO transmission apparatus 300 in the MIMO-OFDM/CDMA communication system according to the present embodiment has feedback information acquiring section 310, transmission control section 320 and data stream generating section 330.

Feedback information acquiring section 310 acquires feedback information including the channel variation detection result transmitted from MIMO reception apparatus 400 described later.

Transmission control section 320 controls the amount of cyclic shift for each cyclic shift section 151 by outputting cyclic shift control information to cyclic shift processing section 150. In addition, transmission control section 320 controls the data stream generation method in data stream generating section 330 by outputting data stream generation command information to data stream generating section 330.

When transmitting a pilot signal sequence, transmission control section 320 outputs a fixed amount of cyclic shift to cyclic shift processing section 150.

When transmitting a data stream, transmission control section 320 outputs data stream generation command information and cyclic shift control information in accordance with the channel variation detection result acquired in feedback information acquiring section 310.

To be more specific, when the channel variation detection result indicates that channels vary slow, the content of data stream generation command information gives a command to generate the same number of data streams with different contents as transmission systems, and the content of cyclic shift control information gives a command to perform cyclic shift with the same amount as at the time of pilot transmission described later.

Meanwhile, when the channel variation detection result indicates that channels vary fast, the content of data stream generation command information gives a command to generate a plurality of types of data streams (the contents differ each other) and generate a plurality of data streams for each type so that the same number of data streams as transmission systems are generated, and the content of cyclic shift control information gives a command to make the amounts of every cyclic shift zero. In addition, data stream generation command information includes information about destination transmission systems to which generated data streams are distributed.

Data stream generating section 330 generates data streams according to the content of data stream generation command information received from transmission control section 320.

To be more specific, in a MIMO transmission mode, data stream generating section 330 generates the same number of data streams with different contents as transmission systems and outputs the generated data streams to spreading section 130.

In addition, data stream generating section 330 generates data streams according to a CDD transmission method. Data stream generating section 330 generates data streams depending on the number of types of data streams (with different contents each other) transmitted through one data OFDM symbol and the number of transmission systems transmitting data streams with the same content. Here, the above-described data stream generation command information also includes information about the CDD transmission method.

Then, data stream generating section 330 distributes the generated data streams to appropriate transmission systems depending on the types of data streams.

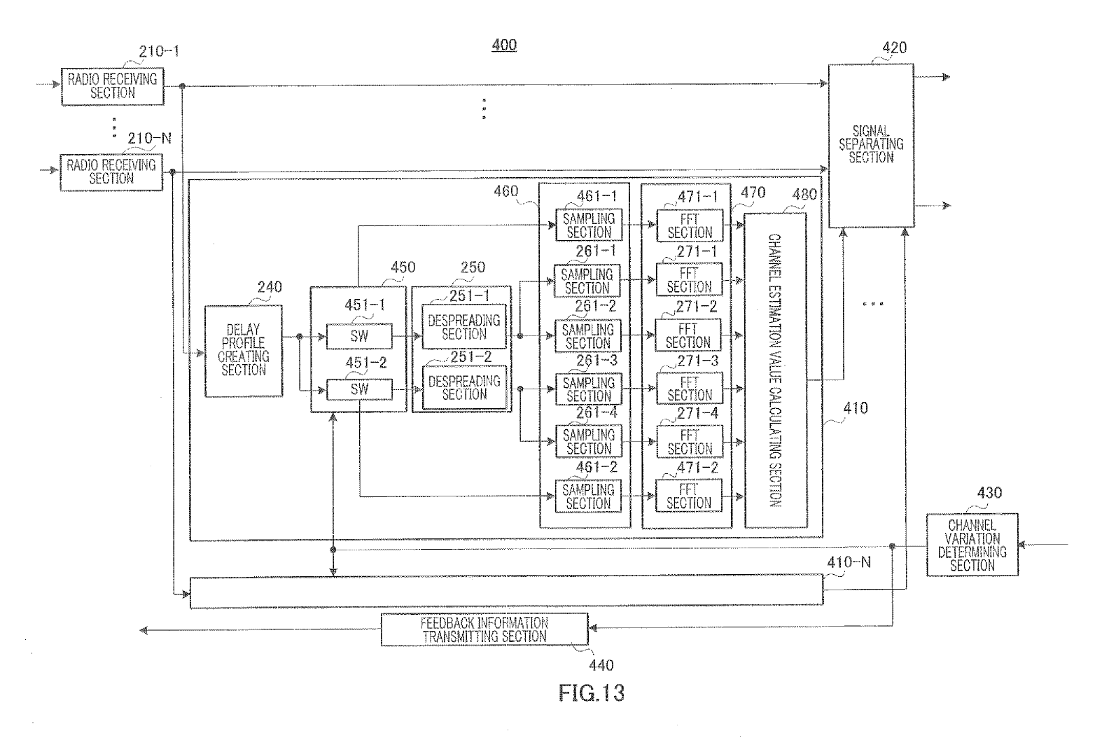

As shown in FIG. 13, MIMO reception apparatus 400 in the MIMO-OFDM/CDMA communication system according to the present embodiment has channel estimating sections 410-1 to N, signal separating section 420, channel variation determining section 430 and feedback information transmitting section 440.

Channel estimating sections 410-1 to N receive receiving OFDM signals from corresponding radio receiving sections 210-1 to N, respectively, and calculate channel estimation values using pilots included in these received OFDM signals.

Channel estimating sections 410-1 to N switch methods of calculating channel estimation values between MIMO reception processing and CDD reception processing. In a case of MIMO reception processing, channel estimating section 410 calculates the channel estimation value for each subcarrier between the corresponding receiving antenna and each transmitting antenna in MIMO transmission apparatus 300. Meanwhile, in a case of CDD reception processing, channel estimation sections 410-1 to N calculate channel estimation values for respective subcarriers between the corresponding receiving antennas and respective “sets of transmitting antennas” that transmit a plurality of pilots spread by different spread codes. Here, each of “sets of transmitting antennas” is composed of transmitting antennas that transmit data streams with the same content on the transmitting side in the case of CDD transmission. In addition, transmission timings of pilots transmitted from transmitting antennas constituting each set of antennas partially overlap.

To be more specific, channel estimating section 410 has switch section 450, path sampling processing section 460, FFT processing section 470 and channel estimation value calculating section 480.

Switch section 450 switches destinations of input delay profiles in accordance with the channel variation detection result received from channel variation determining section 430. That is, since MIMO communication is performed when the channel variation detection result indicates that channels vary slow, switch section 450 outputs input delay profiles to despread processing section 250. Meanwhile, since CDD communication is performed when the channel variation detection result indicates that channels vary fast, switch section 450 directly inputs input delay profiles to sampling processing section 460.

Switch section 450 has a plurality of switches (SWs) 451. Switches 451 correspond to spread codes having been used to spread codes on the transmitting side, respectively. Switches 451 switch destinations of input delay profiles depending on the content of channel variation detection result. Here, on the assumption that two types of spread codes are used on the transmitting side, switch section 450 is provided with switches 451-1 and 2.

Path sampling processing section 460 performs the same processing as in path sampling processing section 260 of embodiment 1 on delay profiles received from despread processing section 250.

Meanwhile, path sampling processing section 460 samples paths in delay profiles directly received from switch section 450 using the time window corresponding to each set of transmission antennas described above. That is, since CDD reception processing is performed in this case, paths are sampled by the time window corresponding to transmission periods in all of the plurality of pilots constituting respective sets. Here, on the assumption that transmitting antennas are divided into two sets on the transmitting side, path sampling processing section 460 is provided with sampling sections 461-1 and 2.

FFT processing section 470 applies Fourier transform processing to each delay profile sampled in path sampling processing section 460. Here, FFT processing section 470 has FFT sections 471-1 and 2 corresponding to path sampling sections 461-1 and 2, respectively.

Channel estimation value calculating section 480 calculates channel estimation values using FFT processing results obtained in FFT processing section 470.

Signal separating section 420 separates a received OFDM signal into a plurality of data streams included in the received OFDM signal using the channel estimation values obtained in channel estimating sections 410-1 to N. Here, signal separating section 420 performs separation processing in accordance with switching between MIMO reception processing and CDD reception processing.

Channel variation determining section 430 determines channel variation based on the error rate of data streams separated by signal separating section 420. Channel variation determining section 430 determines that channels vary fast when the error rate is equal to or higher than a predetermined value and outputs the channel variation detection result indicating this fact to feedback information transmitting section 440 and channel estimating sections 410-1 to N. On the other hand, when the error rate is lower than a predetermined value, channel variation determining section 430 determines that channels vary slow.

Feedback information transmitting section 440 transmits feedback information including the channel variation detection result received from channel variation determining section 430 to MIMO transmission apparatus 300.

Now, operations of MIMO transmission apparatus 300 and MIMO reception apparatus 400 in the MIMO-OFDM/CDMA communication system having the above-described configuration will be described.

MIMO transmission apparatus 300 transmits pilots from respective antennas using two OFDM symbols as shown in FIG. 6A.

When each pilot transmission symbol periods is observed, cyclic shift processing is applied to pilot signal sequences in respective pilot transmission symbol periods with varying amounts of shift per transmission system.

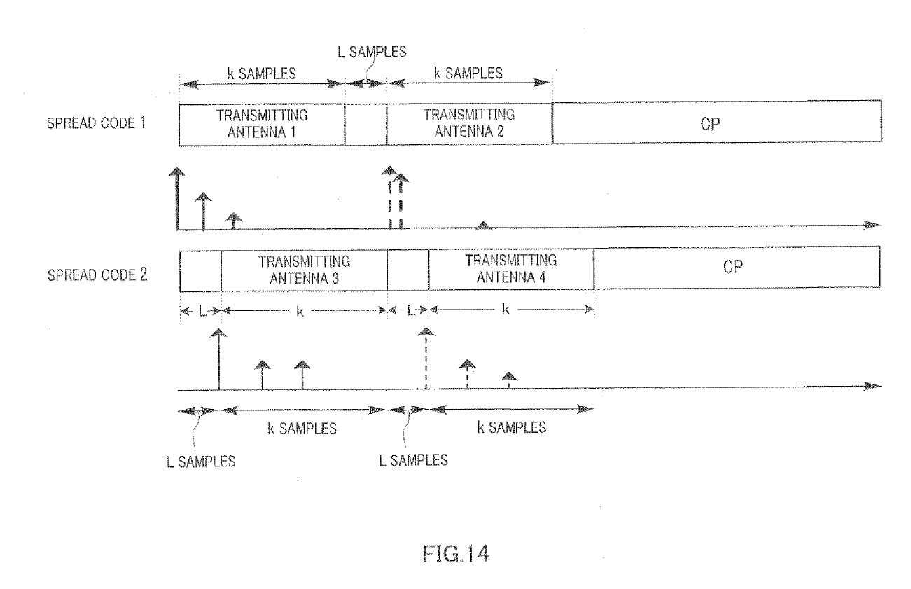

To be more specific, as for pilots spread by spread code 1, the amount of cyclic shift for the pilot signal sequence transmitted from transmitting antenna 1 is zero, and the amount of cyclic shift for the pilot signal sequence transmitted from transmitting antenna 2 is k+L samples, as shown in FIG. 14. Here, L is smaller than k. In addition, the length of k±L samples is equal to or shorter than a CP length.

Meanwhile, as for pilots spread by spread code 2, the amount of cyclic shift for the pilot signal sequence transmitted from transmitting antenna 3 is L samples, and the amount of cyclic shift for the pilot signal sequence transmitted from transmitting antenna 4 is k+2L samples.

That is, MIMO transmission apparatus 300 shifts relatively plurality of pilots spread by the same spread code and transmits these shifted pilots by providing the difference in the amount of cyclic shift greater than a pilot length (here, a difference of k+L samples). Moreover, MIMO transmission apparatus 300 transmits a plurality of pilots spread by different spread codes at transmission timings predetermined samples (here, L samples) shifted relatively.

In addition, spread code 1 has the same phase in all pilot transmission symbol periods while spread code 2 has reverse phases between neighboring pilot transmission symbol periods.

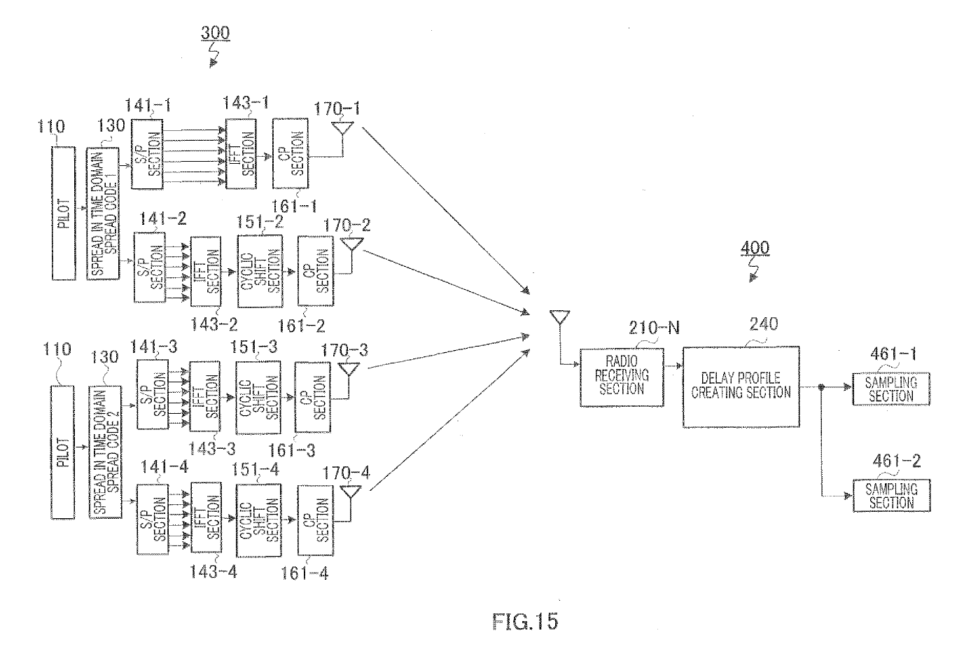

Pilots transmitted as described above go through a plurality of paths as shown in FIG. 15 and then are received in MIMO reception apparatus 400.

During a MIMO communication mode, MIMO reception apparatus 400 performs channel estimation value calculation processing the same as in MIMO reception apparatus 200 of embodiment 1. Here, with the present embodiment, since pilots are transmitted at the transmission timings as shown in FIG. 14, the time windows of sampling sections 261-1 to 4 differ from those of embodiment 1.

That is, a time window of k samples from the beginning position of a pilot OFDM symbol is used in sampling section 261-1 that samples paths for pilots transmitted from transmitting antenna 1. Meanwhile, the time window from k+L samples to 2k+L samples from the beginning position of a pilot OFDM symbol is used in sampling section 261-2 for transmitting antenna 2.

In addition, the time window from L samples to k+L samples from the beginning position of a pilot OFDM symbol is used in sampling section 261-3 for transmitting antenna 3. Moreover, the time window from k+2L, samples to 2k+2L samples from the beginning position of a pilot OFDM symbol is used in sampling section 261-4 for transmitting antenna 4.

Meanwhile, during a CDD communication mode, MIMO reception apparatus 400 samples paths using the time windows corresponding to the periods in which all of the plurality of pilots constituting the above-described respective sets are transmitted.

That is, when pilots are transmitted at the transmission timings as shown in FIG. 14, a first set is composed of transmitting antennas 1 and 3 and a second set is composed of transmitting antennas 2 and 4. Then, sampling section 461-1 that samples paths for pilots corresponding to the first set uses the time window of k+L samples from the beginning position of an OFDM symbol. Thus, CDD reception processing is realized that provides the amount of shift of L samples between transmitting antenna 1 and transmitting antenna 3 by combining multipaths for the beginning k+L samples. Meanwhile, sampling section 461-2 that samples paths for pilots corresponding to the second set uses the time window from k+L samples to 2k+2L samples from the beginning position of an OFDM symbol.

As described above, time windows used in path sampling processing section 460 are switched between the MIMO receiving mode and the CDD receiving mode.

Delay profiles sampled through time windows corresponding to respective sets are inputted to channel estimation value calculating section 480 after being subject to FFT processing in FFT processing section 470. Channel estimation value calculating section 480 calculates channel estimation values based on the received FFT processing results.

In a case of CDD communication, data streams are also transmitted by placing pilots in the same relative temporal positional relationship. That is, the amount of cyclic shift for the pilot signal sequence transmitted from transmitting antenna 1 is zero and the amount of cyclic shift for the pilot signal sequence transmitted from transmitting antenna 2 is k+L samples. The amount of cyclic shift for the pilot signal sequence transmitted from transmitting antenna 3 is L samples and the amount of cyclic shift for the pilot signal sequence transmitted from transmitting antenna 4 is k+2L samples.

Moreover, the data stream content transmitted from transmitting antenna 1 and the content of data streams transmitted from transmitting antenna 3 match and the content of data streams transmitted from transmitting antenna 2 and the content of data streams transmitted from transmitting antenna 4 match.

Thus, transmitted data streams are received in MIMO reception apparatus 400 and are subject to CDD reception processing using the channel estimation values obtained in signal separating section 420.

As described above, according to the present embodiment, cyclic shift processing section 150 in MIMO transmission apparatus 300 shifts, with amounts of shift differing one another, the first pilot signal sequence (for example, the pilot signal sequence transmitted from the above-described antenna 1) spread by the first spread code (for example, the above-described spread code 1) and the second pilot signal sequence (for example, the pilot signal sequence transmitted from the above-described antenna 3) spread by the second spread code (for example, the above-described spread code 2). Then, these cyclic-shifted first pilot signal sequence and second pilot signal sequence are transmitted in the same pilot transmission symbol period from different transmitting antennas.

As described above, two pilot signal sequences transmitted in the same pilot transmission symbol period are spread by different spread codes, so that it allows accurate separation processing on the receiving side. Moreover, it is possible to shift, between pilot signal sequences, timings multipaths corresponding to pilots included in pilot signal sequences appear by changing amounts of cyclic shift processing applied to respective pilot signal sequences. Therefore, an effect of reducing interference can be anticipated, so that it is possible to further improve the accuracy of pilot separation on the receiving side.

Moreover, it is possible to realize the pilot transmission method to allow channel estimation calculation processing by switching between the MIMO receiving mode and the CCD receiving mode by channel estimating section 410 in MIMO reception apparatus on the receiving side.

In addition, MIMO transmission apparatus 300 transmits the first to fourth pilot signal sequences, which are transmitted in the same pilot transmission symbol period. The first and second pilot signal sequences are spread by the first spread code (e.g. the above-described spread code 1) while the third and fourth pilot signal sequences are spread by the second spread code (e.g. the above-described spread code 2). In cyclic shift processing section 150, amounts of cyclic shift for the above-described first to fourth pilot signal sequences are as follows: the difference between the amount of shift of the first pilot signal sequence and the amount of shift of the third pilot signal sequence and the difference between the amount of shift of the second pilot signal sequence and the amount of shift of the fourth pilot signal sequence are the same; and the difference between the amount of shift of the first pilot signal sequence and the amount of shift of the third pilot signal sequence, the difference between the amount of shift of the second pilot signal sequence and the amount of shift of the fourth pilot signal sequence and the difference between the amount of shift of the first pilot signal sequence and the amount of shift of the second pilot signal sequence are the same.

As a result of this, it is possible to efficiently transmit pilots by increasing the number of transmission pilots while channel estimating section 410 switches between the MIMO receiving mode and the CDD receiving mode to enable channel estimation calculation processing in MIMO reception apparatus 400 on the receiving side.

The disclosure of Japanese Patent Application No. 2007-320075, filed on Dec. 11, 2007, including the specification, drawings and abstract, is incorporated herein by reference in its entirety.

### INDUSTRIAL APPLICABILITY

The pilot transmission method, the MIMO transmission apparatus and the MIMO reception apparatus according to the present invention are useful to enable more accurate calculation of channel estimation values.

1. A pilot transmission method in a multiple-input/multiple-output transmission apparatus that transmits pilots from a plurality of transmitting antennas, the method comprising:
generating pilot signal sequences including the pilots as part of the sequences;
spreading the pilot signal sequences by a plurality of spread codes differing each other;
cyclic-shifting a first pilot signal sequence spread by a first spread code and a second pilot signal sequence spread by a second spread code with amounts of shift differing one another; and
transmitting the cyclic-shifted first pilot signal sequence and the cyclic-shifted second pilot signal sequence in the same pilot transmission symbol period from different antennas.

2. The pilot transmission method according to claim 1, wherein a difference between an amount of shift of the first pilot signal sequence and an amount of shift of the second pilot signal sequence is less than a pilot length.

3. The pilot transmission method according to claim 1, wherein:
a third pilot signal sequence spread by the first spread code and a fourth pilot signal sequence spread by the second spread code are transmitted in the same pilot transmission symbol period; and
a difference between an amount of shift of the first pilot signal sequence and an amount of shift of the third pilot signal sequence and a difference between an amount of shift of the second pilot signal sequence and an amount of shift of the fourth pilot signal sequence are the same.

4. The pilot transmission method according to claim 3, wherein the difference between the amount of shift of the first pilot signal sequence and the amount of shift of the third pilot signal sequence, the difference between the amount of shift of the second pilot signal sequence and the amount of shift of the fourth pilot signal sequence and a difference between the amount of shift of the first pilot signal sequence and the amount of shift of the second pilot signal sequence are the same.

5. The pilot transmission method according to claim 1, wherein second pilot signal sequences transmitted in two temporally nearest pilot transmission symbol periods are spread by the second spread code having reverse phases one another.

6. A multiple-input/multiple-output transmission apparatus that transmits pilots from a plurality of transmission antennas, comprising:
a pilot signal sequence generating section that generates pilot signal sequences including the pilots as part of the sequences;
a spreading section that spreads individually the pilot signal sequences by a plurality of different spread codes;
a cyclic shift section that cyclic-shifts a first pilot signal sequence spread by a first spread code and a second pilot signal sequence spread by a second spread code with amounts of shift differing one another; and
a transmitting section that transmits the cyclic-shifted first pilot signal sequence and the cyclic-shifted second pilot signal sequence in the same pilot transmission symbol period from different antennas.

7. The multiple-input/multiple-output transmission apparatus according to claim 6, wherein the cyclic shift section provides a difference between an amount of shift of the first pilot signal sequence and an amount of shift of the second pilot signal sequence less than a pilot length;

8. The multiple-input/multiple-output transmission apparatus according to claim 6, wherein:
a third pilot signal sequence spread by the first spread code and a fourth pilot signal sequence spread by the second spread code are transmitted the same pilot transmission symbol period; and
the cyclic shift section equalizes a difference between an amount of shift of the first pilot signal sequence and an amount of shift of the third pilot signal sequence and a difference between an amount of shift of the second pilot signal sequence and an amount of shift of the fourth pilot signal sequence.

9. The multiple-input/multiple-output transmission apparatus according to claim 8, wherein the cyclic shift section equalizes the difference between the amount of shift of the first pilot signal sequence and the amount of shift of the third pilot signal sequence, the difference between the amount of shift of the second pilot signal sequence and the amount of shift of the fourth pilot signal sequence and a difference between the amount of shift of the first pilot signal sequence and the amount of shift of the second pilot signal sequence.

10. The multiple-input/multiple-output transmission apparatus according to claim 6, wherein the transmitting section transmits second pilot signal sequences spread by the second spread code having reverse phases one another in two temporally nearest pilot transmission symbol periods.

11. The multiple-input/multiple-output transmission apparatus according to claim 6, further comprising a data stream generating section that generates a plurality of identical transmission data streams,
wherein the cyclic shift section provides a difference between an amount of shift of a first transmission data stream and an amount of shift of a second transmission data stream the same as a difference between an amount of shift of the first pilot signal sequence and an amount of shift of the second pilot signal sequence.

12. A multiple-input/multiple-output reception apparatus comprising:
a delay profile creating section that creates delay profiles of received pilots;
a despreading section that despreads the created delay profiles;
a path sampling section that samples paths in the created delay profiles or the created delay profiles after despreading using time windows; and
a channel estimation value calculating section that calculates channel estimation values based on the sampled paths,
wherein the path sampling section switches the time windows between a multiple-input/multiple-output receiving mode and a cyclic delay diversity receiving mode.
